(19) United States
(12) Patent Application Publication
(10) Pub. No.: US 2014/0207566 A1
(43) Pub. Date: Jul. 24, 2014

(54) DEVICE SESSION IDENTIFICATION SYSTEM

(71) Applicant: TRADEMOB GMBH, Sunnyvale, CA (US)

(72) Inventors: Ravi Kamran, Sunnyvale, CA (US); Martin Biermann, Berlin (DE)

(73) Assignee: Trademob GmbH, Sunnyvale, CA (US)

(21) Appl. No.: 13/748,503

(22) Filed: Jan. 23, 2013

(51) Int. Cl. H04L 29/08

(52) U.S. Cl. CPC H04L 67/02; G06Q 30/0277
USPC 705/14.45; 709/217; 705/14.55

(57) ABSTRACT

Methods and systems for the identification of electronic devices between web browser and native application sessions is disclosed. The identification process can function even with interrupted Internet connectivity. A first web browser session establishes a web service connection between an electronic device and a web service system. The web service system delivers a unique token to store on the electronic device in the first web browser session. Subsequent web browser sessions with the web service system can renew storage caches of the unique token and/or make duplicates of information stored on the unique token. Then an upcoming application session can capture the same unique token from a second web browser session with a local web service. The unique token and related information is then submitted to the web service system. The web service server includes backend mechanisms to determine a connection between the first web browser session and the second web browser session.

### FIELD OF INVENTION

This invention relates generally to an advertisement targeting platform, and in particular to a device session identification system for advertisement conversion tracking.

### BACKGROUND

Digital advertisement of applications on electronic devices, especially mobile devices offers a unique opportunity to monetize on device users. Part of advertisement distribution is the ability to link advertisement execution to application installations. Due to the limitations of the device operating systems, it is often difficult to accurately identify advertisement clicks from the electronic devices and link them to eventual installation of the applications advertised.

### DISCLOSURE OF INVENTION

Methods and systems for the identification of electronic devices between web browser and native application sessions is disclosed. The identification process can function even with interrupted Internet connectivity. A first web browser session establishes a web service connection between an electronic device and a web service system. The web service system delivers a unique token to store on the electronic device in the first web browser session. Subsequent web browser sessions with the web service system can renew storage caches of the unique token and/or make duplicates of information stored on the unique token. Then an upcoming application session can capture the same unique token from a second web browser session with a local web service. The unique token and related information is then submitted to the web service system. The web service server includes backend mechanisms to determine a connection between the first web browser session and the second web browser session.

Some embodiments of the invention have other aspects, elements, features, and steps in addition to or in place of what is described above. These potential additions and replacements are described throughout the rest of the specification

### BRIEF DESCRIPTION OF THE DRAWINGS

FIG. 1 illustrates a device identification system for identification of an electronic device.

FIG. 2 illustrates an advertisement platform system to delivery mobile advertisements via advertising networks with a mechanism for conversion tracking.

FIG. 3 is an example of a method of delegating advertisement window sessions on electronic devices.

FIG. 4 is an example of a method of delegating an advertisement execution on an electronic device to a web browser application.

FIG. 5 illustrates an example of a method of processing an incoming advertisement execution request on a supplier web service.

FIG. 6 illustrates an example of a method to ensure the availability of a token record entry per IP address of the requesting client on a web service.

FIG. 7 illustrates an example of a method to install a token in the browser from the web service.

FIG. 8 illustrates an example of a method of a web browser evaluating the contents of a cache manifest to install a token file copy into an application cache of the web browser.

FIG. 9 illustrates an example of a method of a web browser, such as the browser 110 of FIG. 1, requesting a token file URL and loading the unique token contents either from a local cache or its actual remote origin.

FIG. 10 illustrates an example of a method of a web service processing a request to deliver a cache manifest that contains a directive to cache a token file on a certain URL.

FIG. 11 illustrates an example of a method of a web browser requesting a unique token at a token URL.

FIG. 12 illustrates an example of a method of a web service a request for delivering contents of a unique token.

FIG. 13 illustrates an example of a method of a web service processing a request to update an advertisement execution record with a token attached to the request.

FIG. 14 illustrates an example of a method of an electronic device installing an application from an application store.

FIG. 15 illustrates an example of a method of an application on an electronic device being opened after installation.

FIG. 16 illustrates an example of a method of an application on an electronic device serving a local web server to capture a token.

FIG. 17 illustrates an example of a method of a local web server on an electronic device processing a request.

FIG. 18 illustrates an example of a method of a web browser downloading a web document from the local web server of FIG. 16 and executing embedded script to capture token information.

FIG. 19 illustrates an example of a method of the installed application being opened by requesting a URL on the mobile web browser and storing possibly delivered token information in a shared data store.

FIG. 20 is an example of a method of making token requests on a web service and on a local web server on an electronic device to access cache token information.

FIG. 21 illustrates two options of caching a token file in a web browser.

FIG. 22 illustrates a system of token information being shared between web browser sessions and app sessions via storage-based transport of the token in web browser caches and electronic device shared data storages, according to one embodiment of the invention.

FIG. 23 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

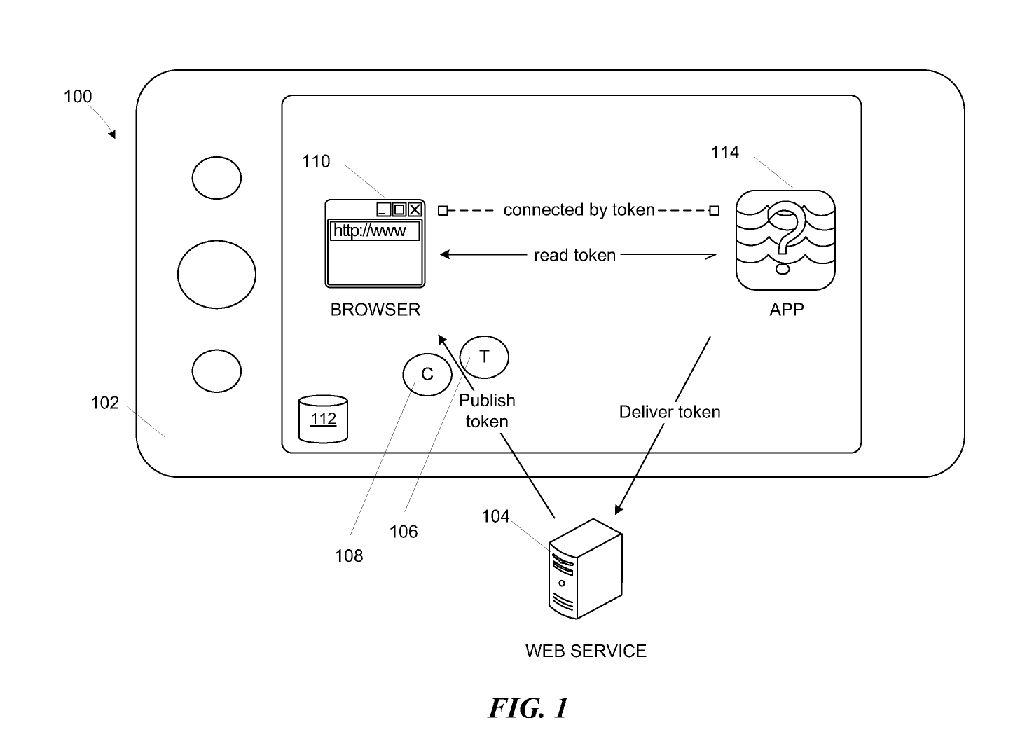

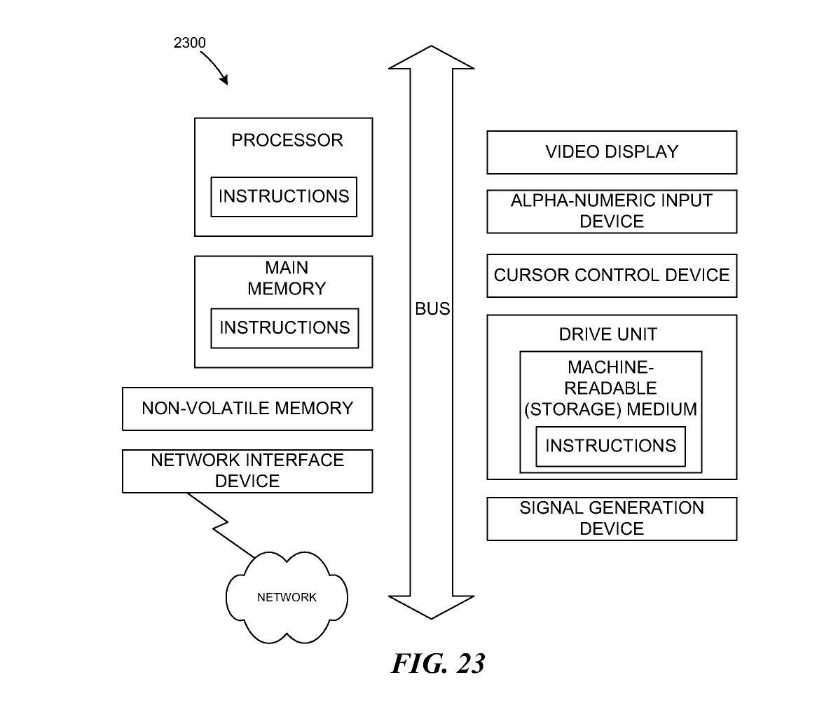

FIG. 1 illustrates a device identification system 100 for identification of an electronic device 102. The device identification system 100 can identify electronic devices during web browser sessions and native application sessions on the electronic devices. The identification of the electronic device 102 can be connection-independent utilizing tokens passed between a web service system 104 and the electronic device 102. The web service system 104 can be implemented by the computer system described in FIG. 23. The identification process of the device identification system 100 can include publishing, installing, accessing, and delivering a token of unique data between a web browser and an application on the same electronic device and between the electronic device and a web service. The electronic device 102 can be a mobile phone, a tablet, a game console, a smart TV, a smart accessory, a laptop, a netbook, or any other device with Internet browsing capability. The electronic device 102 can include a processor and non-transitory storage medium storing modules including native applications, browser application, operating system, or other executable instructions, the modules executable by the processor.

The identification mechanism includes the web service system 104 first publishing a token 106 and/or a browser cookie 108 to a browser 110 on the electronic device 102. The browser 110 is an application on the electronic device 102 capable of making a connection with the web service system 104. It is understood that any electronic device is assumed to have a default web browser application installed and addressable (e.g., Mobile Safari on devices running Apple iOS operating system or Internet on devices running Android operating system). The browser cookie 108 is defined as a piece of data sent from a website and stored in a web browser. In most embodiments, access to the browser cookie 108 is restricted to the web domain of the original website that deposited the cookie. The token 106 and the browser cookie 108 can be stored in a browser cache 112 specific for the browser session with the web service system 104. The token 106 is a unique set of identity information published by the web service system 104 that can be matched to a token record entry on the web service system 104. The token 106 is a file that includes an information structure in plain text format or an encoded format transformed by an encoding or encryption algorithm. Token contents are defined by the web service system 104 for identifying a browser session of the browser 110 and the electronic device 102. In some embodiments, the token 106 is accessible from within any other browser session.

The token 106 can be used to identify an electronic device via browser sessions. For example, the token 106 can be only issued to a device that has not previously received another token previously. If the token 106 has been previously deposited in the browser cache 112, from within a native application 114, the browser 110 can be launched to obtain a HTML document, such as a HTML or a XML document. From the document execution the token 106 is captured from the browser cache 112 of the browser 110. Once the token 106 is captured, the browser 110 can deliver the token 106 or contents of the token 106 to the native application 114. The native application 114 can then deliver the token 106 or the contents of the token 106 to the web service system 104. The token 106 is stored on the electronic device 102 again if the token 106 is no longer available in the browser cookie 110 or installed in the browser caches 112.

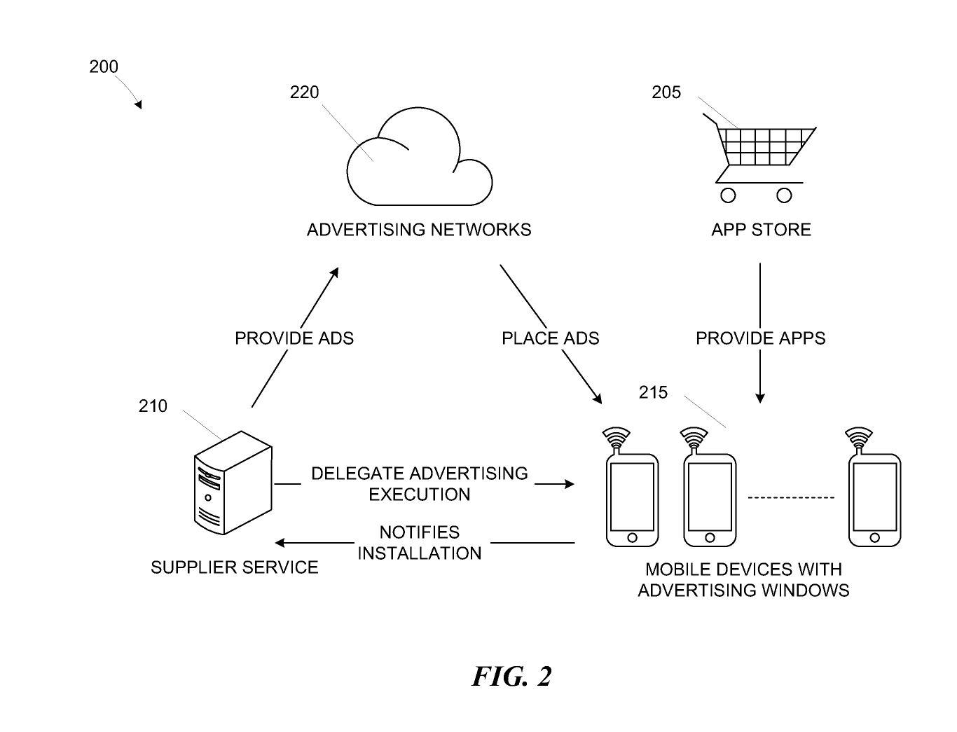

FIG. 2 illustrates an advertisement platform system 200 to delivery mobile advertisements via advertising networks with a mechanism for conversion tracking. A conversion in advertisement methodology is the execution of an advertisement by an end user for achieving the advertisement goal. In one embodiment, the goal of an advertisement is to download a certain application from an application store 205 of the electronic device platform to an electronic device 215. The electronic device 215 can be the electronic device 102 of FIG. 1. The download can require a preceding purchase of the application. In the illustration, a supplier service system 210 provides advertisements to an advertisement network system 220. The advertisement network system 220 can be implemented by the computer system 2300 of FIG. 23. The supplier service system 210 can be the web service system 104 of FIG. 1. The advertisement network system 220 delegates predefined advertisement windows on the electronic device 215. The advertisement network system 220 places advertisements in windows during advertisement window sessions. When the user of the electronic device 215 executes an advertisement, a web link (e.g., A URL) is called to let the supplier service system 210 delegate the execution and to redirect the user to the application store 205. When the application was downloaded from the application store 205 and installed to the electronic device 215, the application notifies the supplier service system 210 about the installation. The supplier service system 210 can then match the advertisement execution with the installation to track a conversion.

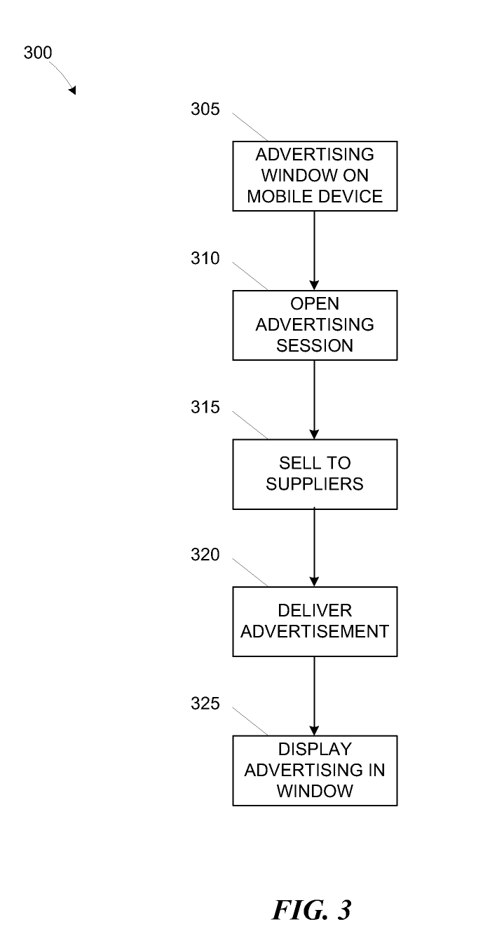

FIG. 3 is an example of a method 300 of delegating advertisement window sessions on electronic devices. The method 300 includes providing an advertisement window on an electronic device in a step 305. The electronic device can be the electronic device 215 of FIG. 2 or the electronic device 102 of FIG. 1. The advertisement window can be installed via an advertisement application. The method 300 continues with a step 310 of opening an advertisement session on the electronic device. The session can be delegated by the advertisement network system 220 of FIG. 2 that sells the session to a supplier, such as the supplier service system 210 of FIG. 2. Thus, the method 300 can include a step 315 of selling an advertisement session to the supplier service system 210. Once the advertisement session is sold to the supplier service system 210, the advertisement window is registered to the supplier service system 210. Following the step 315 in a step 320 of the method 300, the supplier service system 210 delivers the actual advertisement window contents to the advertisement network system 220. Upon delivering the advertisement content, the method 300 includes a step 325 of displaying the advertisement on the electronic device advertising window.

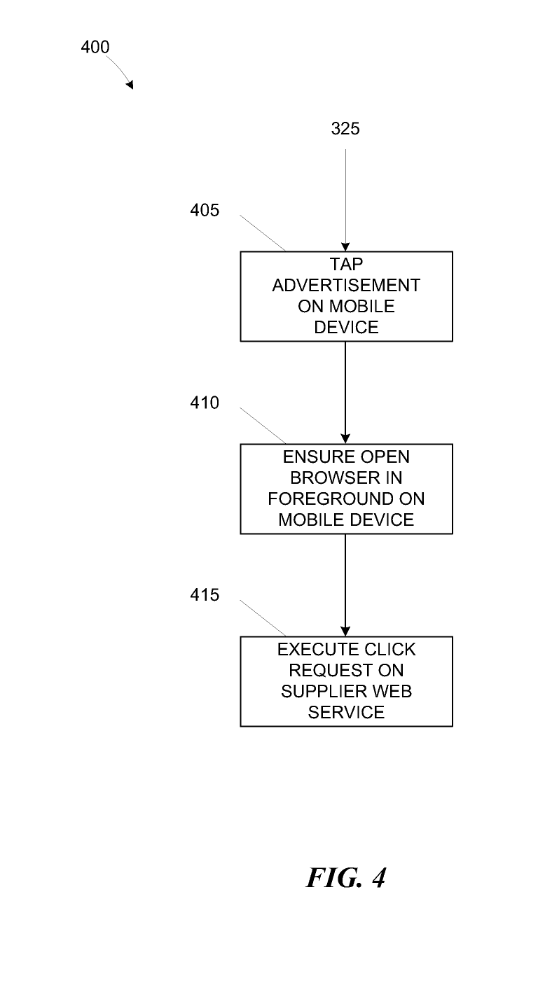

FIG. 4 is an example of a method 400 of delegating an advertisement execution on an electronic device to a web browser application. The method 400 can be executed on the electronic device following the method 300 of FIG. 3. The method 400 includes a step 405 of receiving a user interaction from the user on an advertisement on the electronic device, such as a click on the advertisement on the electronic device 102 of FIG. 1. Following the step 405, the web browser, such as the browser 110, is send to foreground by a network request called “Click Request” to obtain delegation for the advertisement execution from a supplier web service, such as the supplier service system 210 of FIG. 2. The network request can be a HTTP request. A default web browser application is configured on the electronic device 102 in most embodiments in this disclosure. The web browser application can be brought to foreground by calling a certain method on an operating system interface. After the web browser is brought to the foreground of the electronic device, the electronic device can send a message to the supplier web service to execute an advertisement interaction protocol, such as a “Click Request”.

The default web browser application to call can depend on an advertisement publisher application associated with presenting the advertisement on the electronic device. The default web browser may be sandboxed such that any data cached during the browser session cannot be saved for access on the next browser session. The publishing software can redirect the click request via the sandboxed browser or a regular browser. In one embodiment, the web service can influence the publisher application to specifically activate a non-sandboxed web browser via a plug-in, a SDK, or an API message.

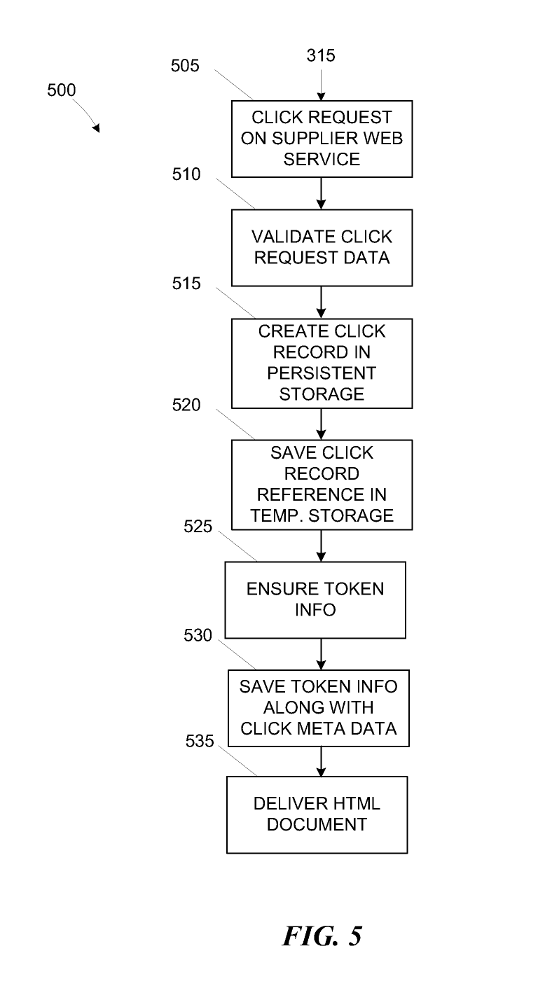

FIG. 5 illustrates an example of a method 500 of processing an incoming advertisement execution request on a supplier web service, such as the supplier service system 210. The processing can include handling a Click Request on the supplier web service. The method 500 executed on the supplier web service, such as the supplier service system 210 of FIG. 2, can be in response to the method 400 running on the electronic device of FIG. 4.

The method 500 includes a step 505 of receiving a click request from an electronic device on the supplier web service. The supplier web service can validate the click request in a step 510 of the method 500. Following the step 510, the method 500 can then create a click record about the click request in a persistent storage in a step 515. Following the step 510, the method 500 can also include saving the click record reference in a temporary storage on the supplier web service in a step 520. The reference to the click record is kept for some time in the temporary storage such that stored tokens can be renewed in a quick way when accessing the web service.

The method 500 then follows with the supplier web service ensuring that there is a token record entry available on the supplier web service for the IP address of the electronic device in a step 525. The token record entry is saved in the temporary storage to bridge multiple requests of the token on the request possibly arriving simultaneously. This may ensure that the same token is responded back for the same IP address of the click execution requester during the whole process of the click (e.g., click request, cache manifest, token loading with another browser caching, browser cache token capture, and update call).

In one embodiment, at a step 530 of the method 500, the supplier web service can save the unique token, such as the token 106, along with the Click Request meta data in the click record. The click request meta data includes further information about the corresponding advertisement that was executed. Following the step 530, the method 500 follows with a step 535 of publishing or delivering a web document, such as a HTML document, containing further delegation steps with the request response.

In some embodiments, the reference to the click record can be saved besides the token in the temporary storage, with no direct connection between those two data sets inside the temp storage. The click record can subsequently be updated (see below) during an update call with the token information captured through the web browser. This captured token information is not available when the click request first hits the web service system.

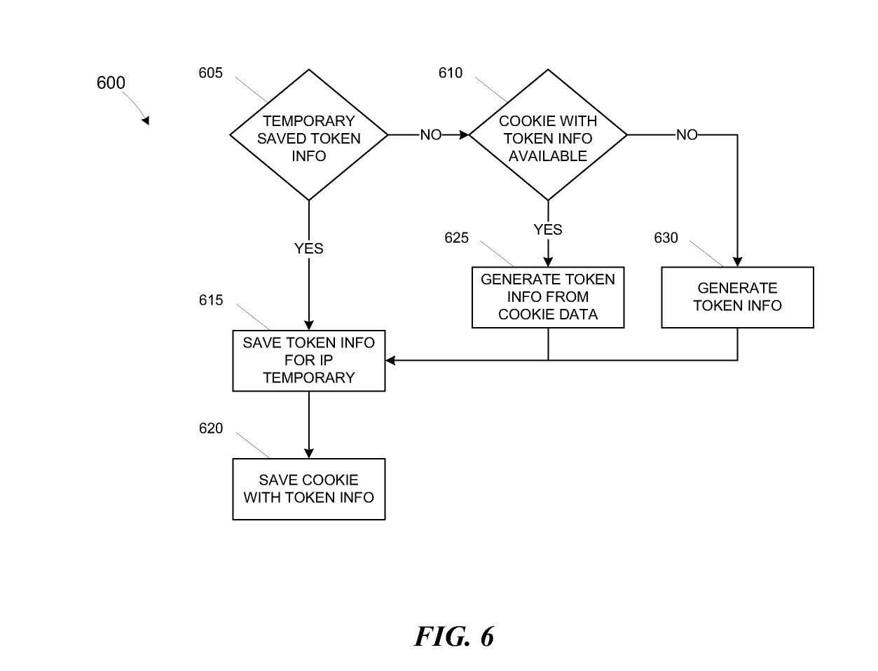

FIG. 6 illustrates an example of a method 600 to ensure the availability of a token record entry per IP address of the requesting client on a web service, such as the supplier service system 210 of FIG. 2. The method 600 can be in response to the step 525 of FIG. 5. The method 600 can include a step 605 of determining whether a token record entry of the IP address of the current request is stored on a temporary storage of the supplier web service. The token record entry stores the information of a unique token, such as the token 106, on the web service. The temporary storage on the electronic device in this example stores the token record entry for a limited time. If and when there already is a token record entry in that temporary storage, the token record entry is again saved to that the temporary storage to extend its inhered storage lifetime in a step 615 of the method 600. After the step 615, the supplier web service can again save a browser cookie, such as the browser cookie 108 of FIG. 1, containing the token information with the browser session on the electronic device in a step 620 of the method 600.

If and when there is no token record entry stored on the temporary storage, the method 600 includes a step 610 of determining whether a browser cookie, such as the browser cookie 108, with the token record entry is available through the click request. For example, HTTP headers of the click request can be scanned for a cookie that includes the token in the step 625.

If and when the cookie including the token information is found through the click request, the method 600 continues to a step 625 to generate token information regarding the unique token from the cookie found. If and when a cookie including the token information is not found through the click request, the method 600 continues to a step 630 to generate a new token record entry of a new unique token to place in the temporary storage of the web service. Following the step 630, the method 600 continues to the step 615 described above. The method 600 can be an asynchronous process that can be executed parallel to other methods that initiated the method 600.

The method 600 is advantageous because it can ensure (e.g., by the step 630) that where there was an advertisement interaction spawning a click record some time ago and the browser cookie was deleted or rejected at the time, the token can still be installed in the browser caches for retrieval. In the case of the step 630 where on the current click no cookie can found, a new token is created to ensure the new token can be distributed.

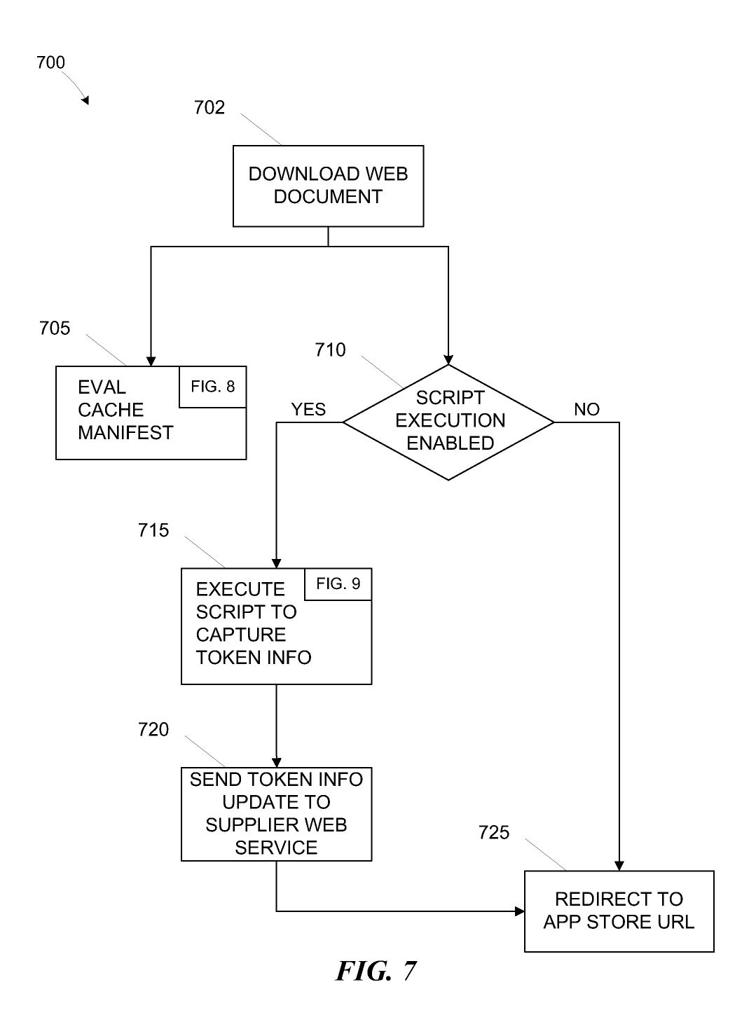

FIG. 7 illustrates an example of a method 700 to install a token, such as the token 106 of FIG. 1, in the browser from the web service. In response to the step 520, the web browser, such as the browser 110 of FIG. 1, can download the web document published by the web service, such as the supplier service system 210 of FIG. 2, in a step 702 of the method 700. The web document incorporates a cache manifest file that lists certain resources to be cached by the web browser for offline usage of web applications. The cache manifests and the evaluation of cache manifest in browser applications can be part of the HTML5 specifications. The method 700 continues to a step 705 of evaluating the cache manifest from the web document. Following the evaluation, the method 700 follows with determining whether browser-side script execution is enabled in a step 710. The step 705 and the step 710 can be performed asynchronously. That is, the step 705 and the step 710 can be performed either in parallel or in sequence.

The step 710 can determine if browser-side script, such as JavaScript, is enabled on the web browser. If and when browser-side script execution is enabled on the electronic device, the method 700 continues with executing an embedded script of the web document to download and decode a token object based on a link stored in the cache manifest in a step 715. The token object can be encoded in a JavaScript file, an image file, an audio file, a text file, or any combination thereof. In some embodiments, the token object can be encoded as an image file (e.g., a JPEG or a GIF), such that even when browser-side scripting is disabled, the image file can be cached by the web browser. Later when the browser-side scripting is enabled, the decoding script can then decode the image file. In other embodiments where the token object is encoded as a JavaScript file, the token object can be stored via a web cookie instead via the browser cache.

The token object can be encrypted such that only logics available on or supplied by the web service are able to decode the encryption. A decoder script can be downloaded via a link in the web document to capture the unique token stored in the token object. The decoder script can be executed by the web browser to parse and decrypt the token object and extract the unique token. In response to capturing the unique token, the method 700 follows with a step 720 of submitting the unique token to the web service to update corresponding records (i.e., The click record). It is noted that this can be an important task according to one embodiment, where this will update token information A on the web service as the token information was generated due to missing information in a web cookie, such as a HTTP cookie, with token information B captured in the web browser. Following the step 720 or when browser-side script execution is not enabled, the method 700 continues to a step 725 of redirecting the browser session to an application store, such as the application store 205 of FIG. 2.

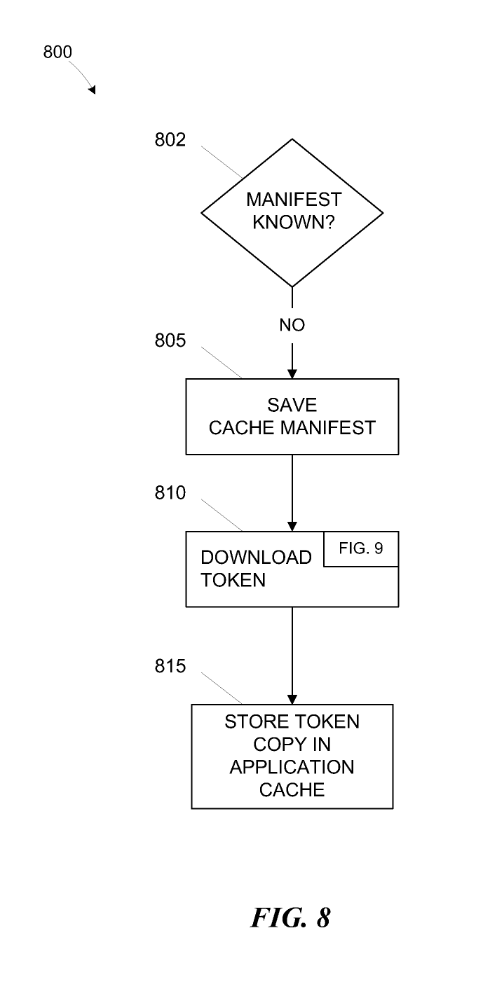

FIG. 8 illustrates an example of a method 800 of a web browser, such as the browser 110 of FIG. 1, evaluating the contents of a cache manifest to install a token file copy into an application cache of the web browser. The method 800 can be in response to execution of the step 705 of FIG. 7. The method 800 can include a step 802 of determining whether the downloaded cache manifest is already known by the browser, such as a cache manifest saved on the browser cache 112 or a change in byte size of a previously known cache manifest for the same URL. If the current cache manifest is unknown, in a step 805, the cache manifest file is updated and saved by the browser. The cache manifest contains a reference to a token URL with cache instruction to save the unique token. The method 800 continues to a step 810 where the web browser downloads the unique token by accessing the token URL. Once the unique token is downloaded, the unique token is stored as a copy in an application cache inside browser at a step 815. The application cache is a separated cache. Application caches are organized in Application Cache Groups identified by absolute URL of the cache manifest.

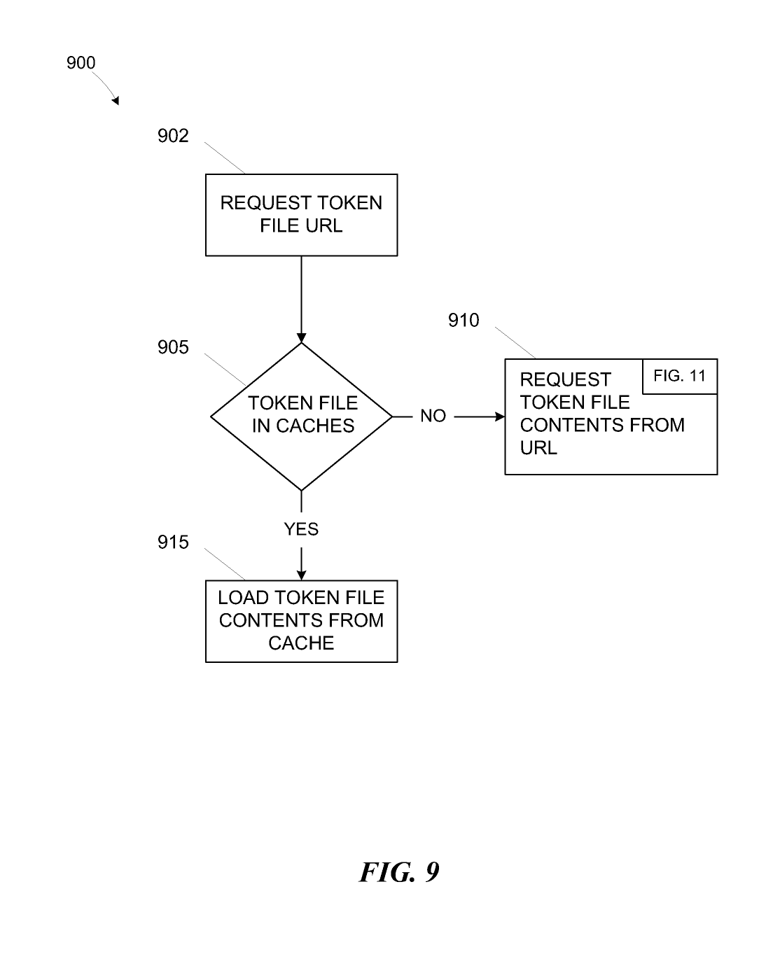

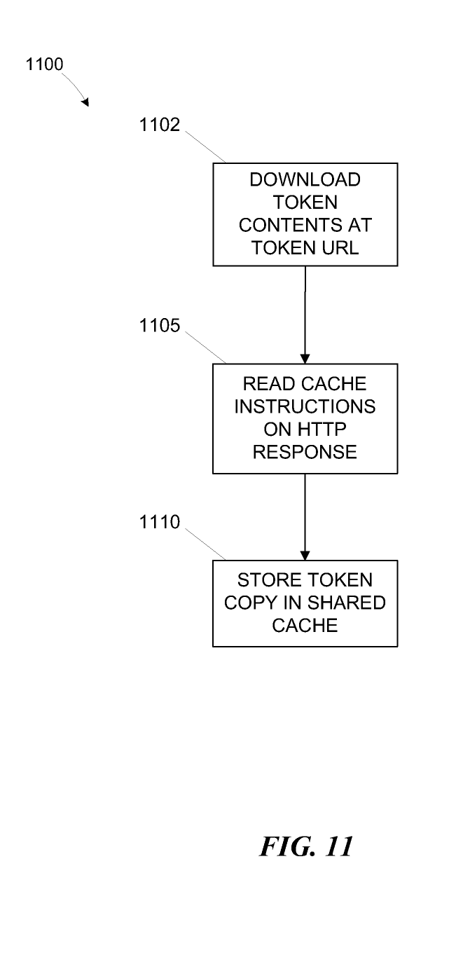

FIG. 9 illustrates an example of a method 900 of a web browser, such as the browser 110 of FIG. 1, requesting a token file URL and loading the unique token either from a local cache or its actual remote origin. The method 900 can be in response to the step 810 of FIG. 8. The web browser can recognize a token file request based on a URL request in a step 902 of the method 900. The method 900 then continues to a step 905, where the web browser can determine whether a valid copy of the unique token is stored in local caches, such as the browser cache 112 of FIG. 1, of the web browser. Valid here means that token file has not expired which is indicated by either a cache manifest reference that is still up-to-date or an expiration date that was delivered with the token file when downloaded previously. If the web browser has no valid local copy of the token file, then the method 900 continues to a step 910 of downloading the token file from the token URL. FIG. 11 further illustrates how the unique token can be downloaded from the token URL. If the web browser has a valid local copy of the unique token file, the web browser can load the unique token from the valid local copy in a step 915 of the method 900.

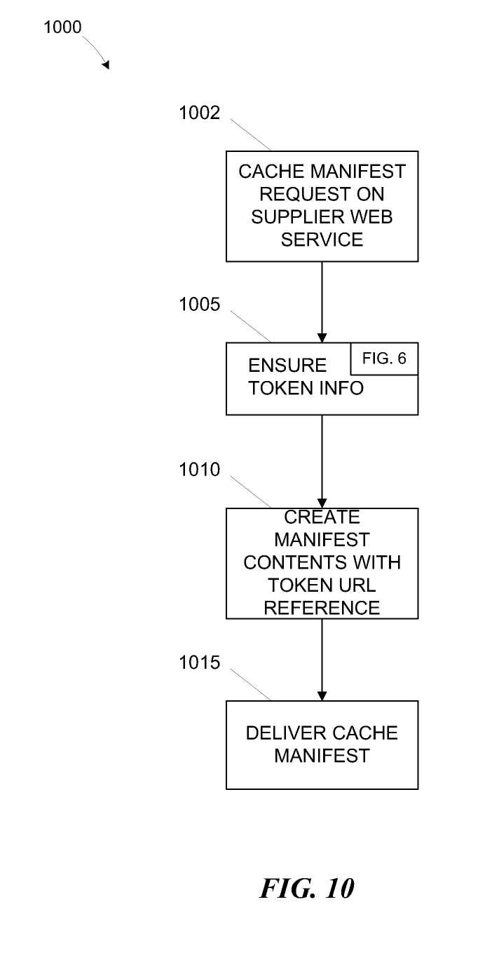

FIG. 10 illustrates an example of a method 1000 of a web service, such as the supplier service system 210 of FIG. 2, processing a request to deliver a cache manifest that contains a directive to cache a token file on a certain URL. The method 1000 can be in response to the step 702 to download the web document including the cache manifest. The method 1000 can include a step 1002 of receiving a request from the client device, such as the electronic device 102, to provide a cache manifest. The method 1000 can include a step 1005 of ensuring that a token matching the IP address of the requesting client device is available on the web service. FIG. 6 illustrates an example of how the step 1005 can be implemented. The method 1000 then includes a step 1010 of generating a cache manifest including generating a token URL based on the ensured token information. At a step 1015, the method 1000 continues by delivering the cache manifest to the requesting device.

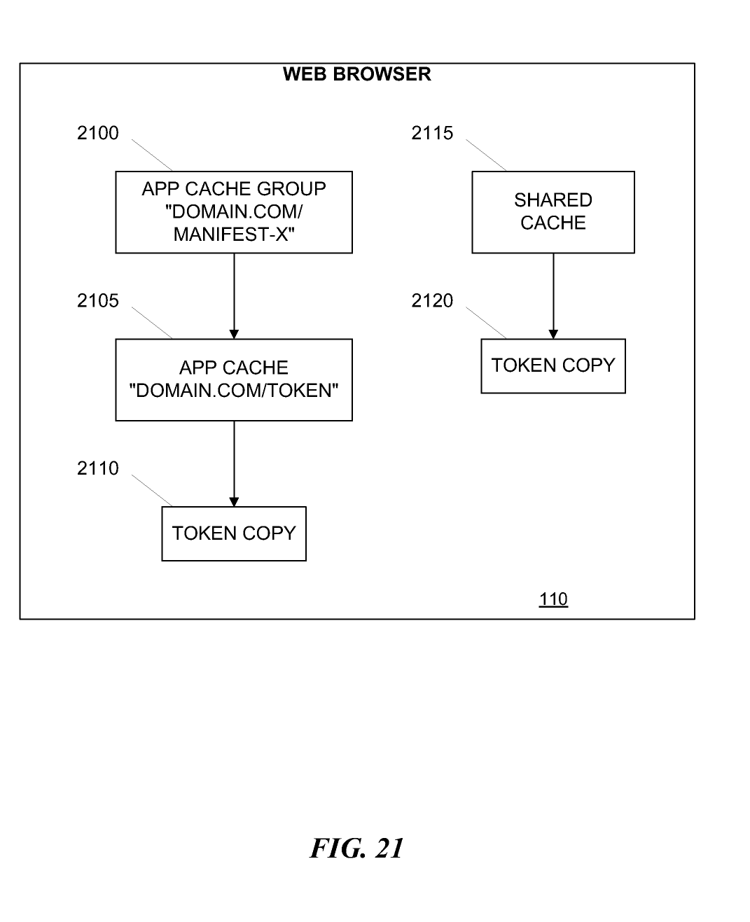

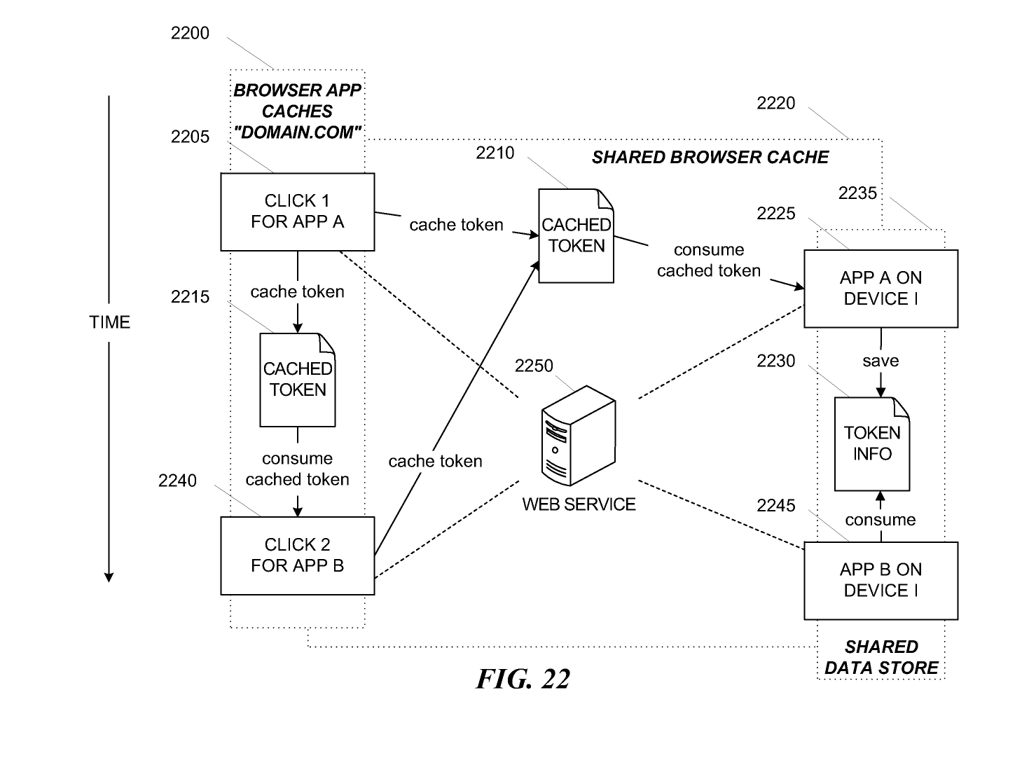

FIG. 11 illustrates an example of a method 1100 of a web browser, such as the browser 110 of FIG. 1, requesting a unique token at a token URL. The method 1100 can be in response to the step 910 of FIG. 9. The method 1100 can begin with a step 1102 of downloading a unique token from the token URL. Then the unique token can be downloaded from a HTTP response by accessing the token URL. At a step 1105, the method 1100 further includes reading headers of the HTTP response to extract cache instructions for the unique token file. Based on the cache instruction, the method 1100 can include a step 1110 of storing a copy of the unique token in a shared cache of the web browser. In some embodiments, a copy of the unique token can be cached again even if the unique token has already been cached previously to extend the lifetime of the cache. FIGS. 21 and 22 further illustrate the shared cache of the web browser.

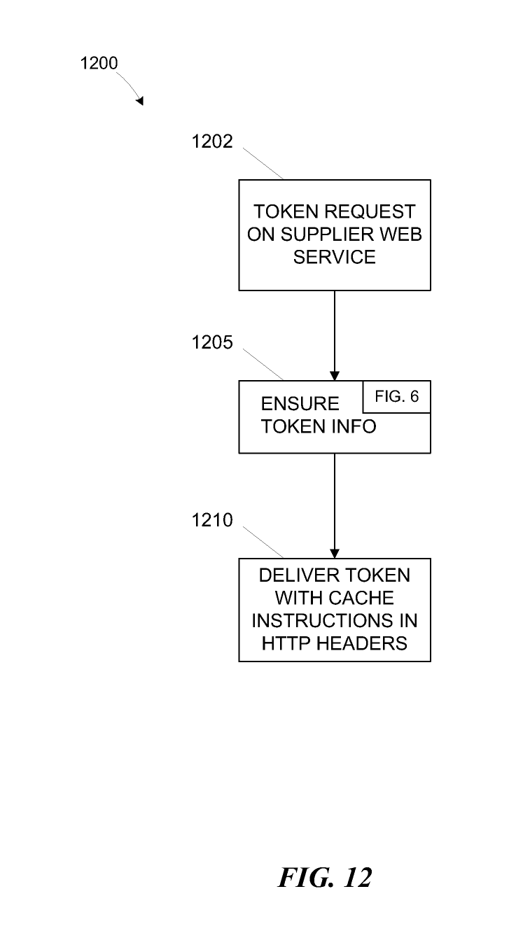

FIG. 12 illustrates an example of a method 1200 of a web service, such as the supplier service system 210 of FIG. 2, processing a request for delivering a unique token. The method 1200 can be in response to the step 1102 of FIG. 11. The method 1200 includes a step 1202 of receiving a token file request. The method 1200 follows with a step 1205 of ensuring token information is available as illustrated in FIG. 6. The step 1205 ensures that a unique token is identified based on the IP address of the request for the unique token. The method 1200 then continues to a step 1210 of delivering a request response including the ensured unique token along with cache instructions (i.e., cache for one year) assigned to headers of the request response.

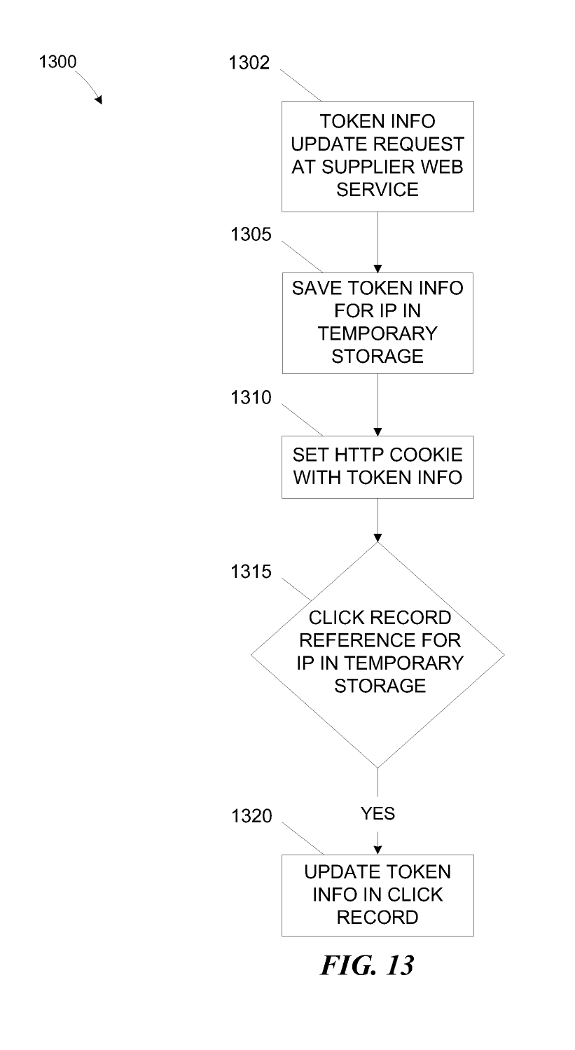

FIG. 13 illustrates an example of a method 1300 of a web service, such as the supplier service system 210 of FIG. 2, processing a request to update an advertisement execution record with a token attached to the request. The method 1300 includes a step 1302 of receiving a request to update records with the supplied token. The method 1300 then continues to a step 1305 of saving the supplied token to a token record entry having the IP address of the request as a key to the token record entry in the temporary storage of the web service. The method 1300 follows with a step 1310 of assigning the token in form of a web cookie to a request response. At a step 1315 of the method 1300, the web service determines whether there is a click record identified by the IP address of the request in the temporary storage. If and when the click record is found, the method 1300 continues to a step 1320 of updating the token record entry in the click record with that provided with the request.

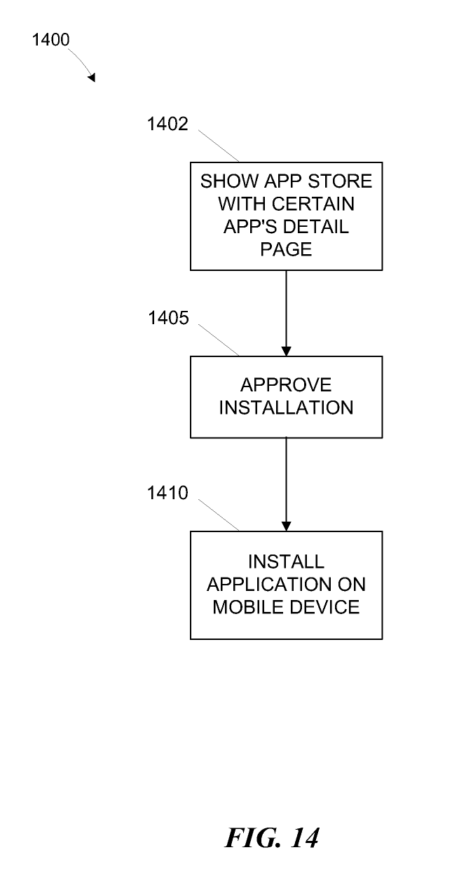

FIG. 14 illustrates an example of a method 1400 of an electronic device, such as the electronic device 102 of FIG. 1, installing an application, such as the native application 114 of FIG. 1, from an application store, such as the application store 205 of FIG. 2. In this example, the method 1400 starts with a step 1402 where the electronic device, according to its platform, displays the application store with an application page containing detailed information about an application. The method 1400 then continues with a step 1405 of receiving an approval to install the application via a device interface from the user. The approval can be based on a user purchase of the application offered on the detailed page. The approval can also be based on confirmation of a free installation of the application. The method 1400 then follows with a step 1410 of installing the application on the electronic device. The application hereon can be referred to as the “installed application”.

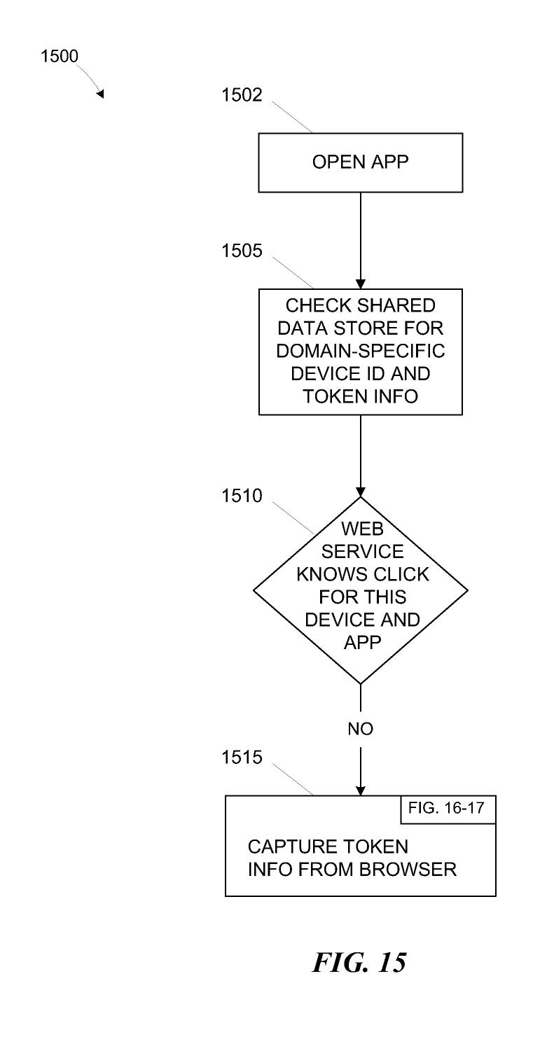

FIG. 15 illustrates an example of a method 1500 of an application, such as the native application 114 of FIG. 1, on an electronic device being opened after installation, such as after the method 1400. In this example, the installed application on the electronic device is opened in a step 1502. The installed application can then check for shared data stores on the electronic device containing a domain-specific unique device identifier or previously obtained token information in a step 1505. The method 1500 then continues to a step 1510 where the application asks the web service, such as the supplier service system 210 of FIG. 2, whether the application should attempt to capture a unique token, such as the token 106, from a web browser, such as the browser 110 of FIG. 1.

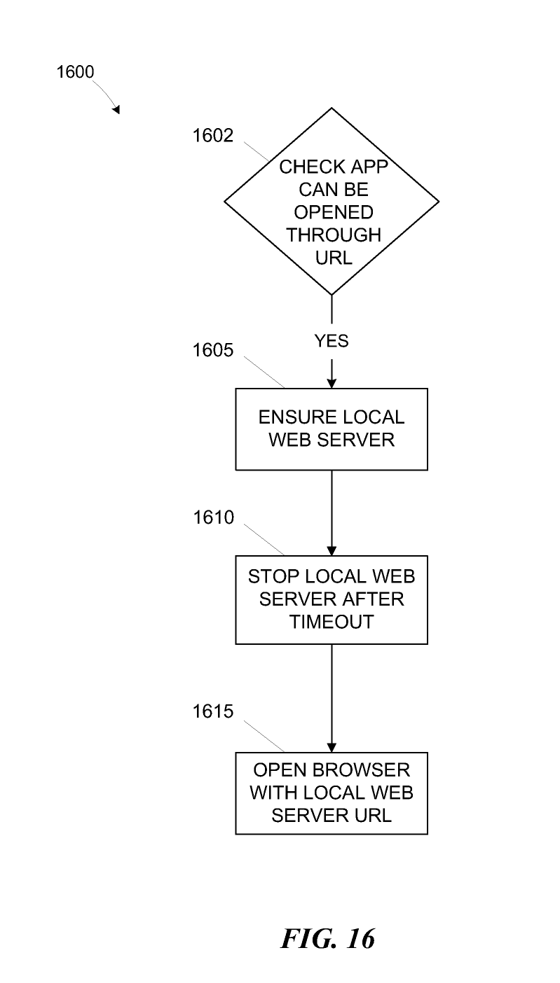

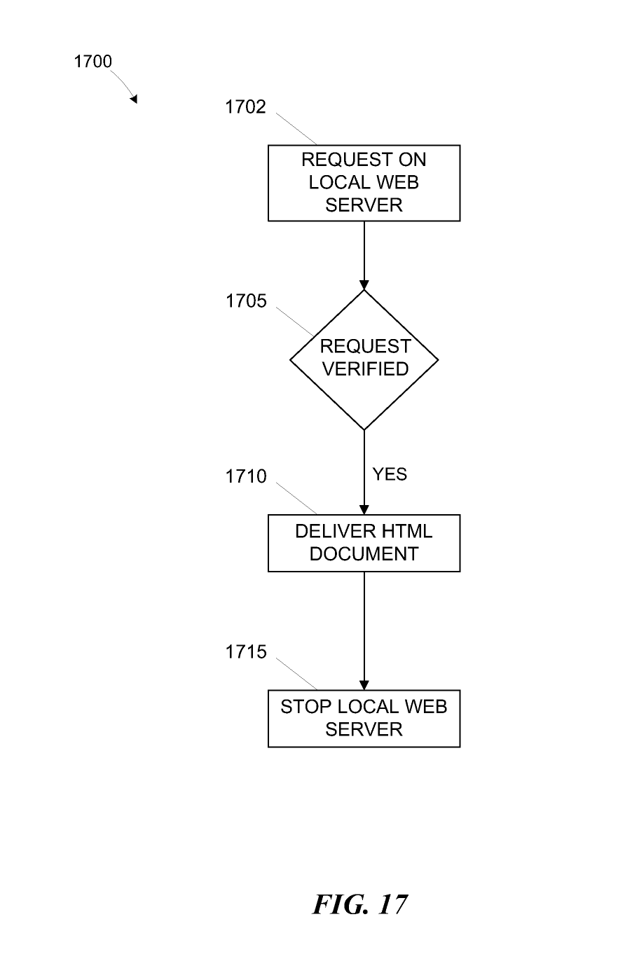

The web service can determine whether the installed application should capture the unique token by determining whether the web service has processed a click request to download the application. In the step 1510 when the application is asking the web service, the application provides identifying information about the application and the electronic device environment. If the web service cannot match a click request for that application installation, the application can proceed to capture the token from the web browser in a step 1515 of the method 1500. FIGS. 16 and 17 illustrate how the unique token can be captured by the application.

FIG. 16 illustrates an example of a method 1600 of an application, such as the native application 114 of FIG. 1, on an electronic device, such as the electronic device 102 of FIG. 1, serving a local web server to capture a token, such as the token 106 of FIG. 1. The method 1600 can be in response to the step 1515 of FIG. 15. The installed application can verify whether the installed application can be opened through an URL in a step 1602. Here, opening an application on the electronic device means bringing it into foreground. If the application is already running on electronic device, then opening includes starting the application on the electronic device and then bringing it into to the foreground.

These steps to open the application are handled by an operating system of the electronic device, where the installed application can be opened via requesting an URL of the application. Whether an URL is considered to reference an application can be identified by an URL scheme registered on the operating system. The registered URL scheme can launch an application when a URL to the URL scheme is requested on the operating system, such as via the browser 110.

If the installed application can be opened via a URL, a local web server is established on the electronic device listening on a network socket on the electronic device in a step 1605. The step 1605 includes verifying that the local web server is available at that network socket. The step 1605 can also include verifying that only the electronic device can establish a connection with the local web server. In some embodiments, any provided resources of the local server can be made available via alphanumeric hash identifiers only temporarily available to the electronic device for a limited time after timeout. The method 1600 then continues to a step 1610 where the local web server stops operating after timeout. The timeout duration can be set to one to five seconds or five to ten seconds. At a step 1615, the method 1600 includes requesting a resource at the local web server via the web browser, such as the browser 110.

The use of the local web server has been discovered to be advantageous because the electronic device does not need to have a reliable internet connectivity to execute the methods 1600, 1700, and 1800, allowing retrieval of the token. The goal of the device identification system 100 can include matching installation of the installed application to the token generated from an advertisement interaction. Further, the device identification system 100 can further get the token related to organic installs of applications to further understand the consumer user of the electronic device.

FIG. 17 illustrates an example of a method 1700 of a local web server on an electronic device, such as the electronic device 102 of FIG. 1, processing a request. The method 1700 can be in response to the step 1615 of FIG. 16. In a step 1702 of the method 700, the local web server can receive a request for a resource. In a step 1705, the method 1700 can include verifying that the request originates from the same device running the local web server. The step 1705 can also include verifying that the request originates from a local web browser, such as the browser 110 of FIG. 1. Once the request is verified, the method 1700 can include a step 1710 of delivering the requested resource to the requesting browser. The requested resource can be the unique token placed in the shared cache by the step 1110 of FIG. 11. The method 1700 then ends with a step 1715 of immediately stopping the local web service after the requested resource is delivered.

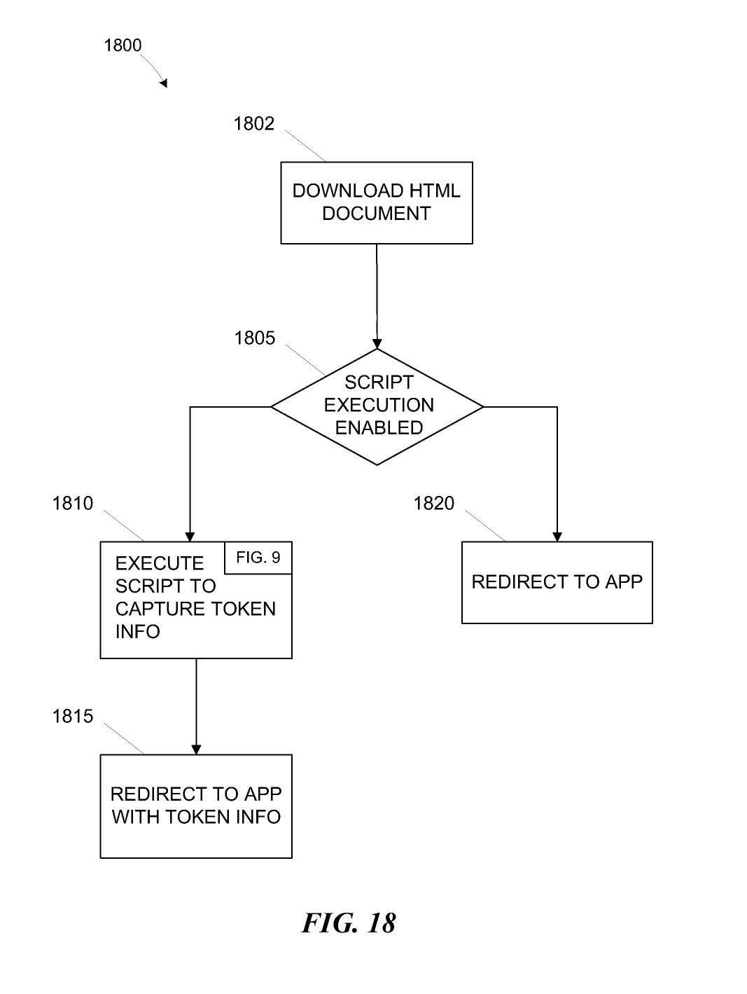

FIG. 18 illustrates an example of a method 1800 of a web browser, such as the browser 110 of FIG. 1, downloading a web document from the local web server of FIG. 16 and executing embedded script to capture token information. The method 1800 includes steps that are equivalent to the steps of the method 700, where the web browser interacts with the local web server instead of the web service of FIG. 7.

The method 1800 includes a step 1802 of downloading the web document. Then the method 1800 includes a step 1805 of determining whether execution of embedded script code is enabled. If and when execution of embedded script code is disabled, the method 1800 includes a step 1820 of redirecting the electronic device to the installed application, such as the native application 114 of FIG. 1, via the URL scheme described in FIG. 16. Redirection to the installed application is accomplished by requesting an URL containing the corresponding URL scheme. If and when execution of embedded script is enabled, the method 1800 includes a step 1810 of executing script code embedded in the downloaded web document to capture a unique token from the web browser. How the web browser can capture the unique token is described above in FIG. 9. Upon capturing the unique token, the method 1800 continues to a step 1815 of redirecting the electronic device to the installed application and delivering the captured unique token along with the request to open the installed application.

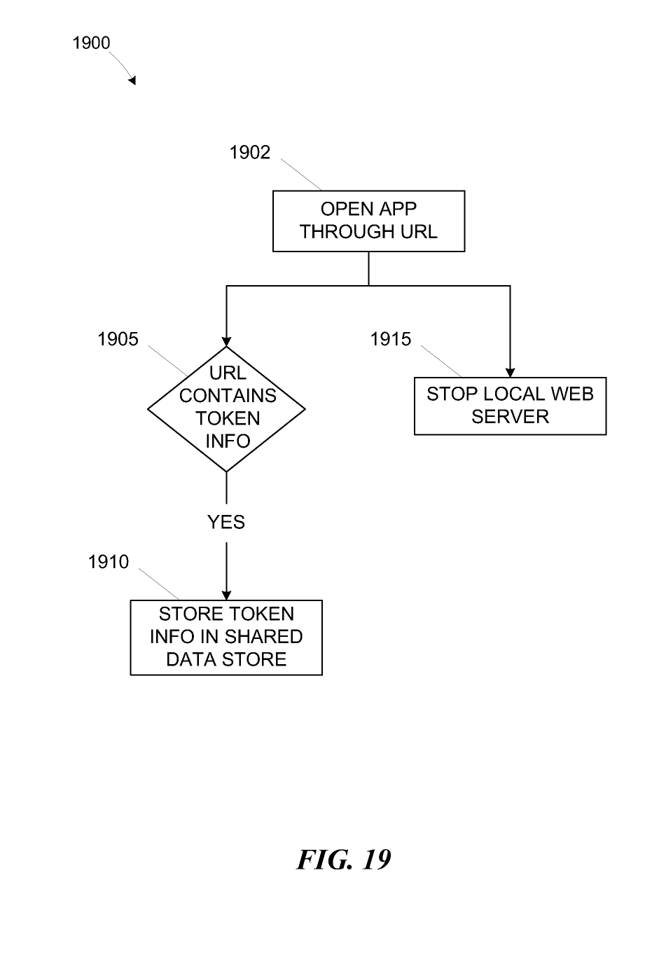

FIG. 19 illustrates an example of a method 1900 of the installed application being opened by requesting a URL on the mobile web browser and storing possibly delivered token information in a shared data store. The method 1900 can be made in response to the step 1815 of FIG. 18.

In a step 1902, the installed application is opened via accessing a URL scheme registered to the installed application. In a step 1915, the local web server is stopped upon opening of the installed application. This is consistent with the step 1715 of FIG. 17. In parallel, the installed application can check if the URL scheme request includes token information in a step 1905 of the method 1900. If and when the URL scheme request includes token information, the installed application can store such information in a shared data store in a step 1910. It is noted that in at least one embodiment of the invention, the shared data store is accessible by other applications.

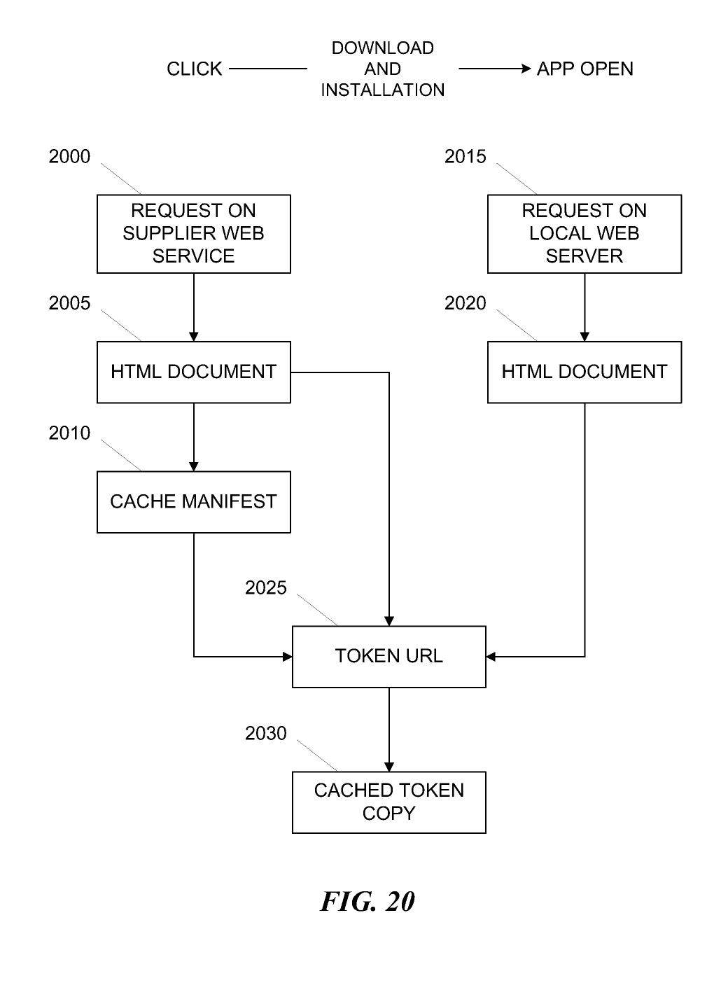

FIG. 20 is an example of a method of making token requests on a web service and on a local web server of an electronic device to access cache token information. The web service can be the supplier service system 210 of FIG. 2. A web browser, such as the browser 110, can request a web document on the web service in a step 2000. The web browser can then download the web document in a step 2005. According to at least one embodiment, the web document references a token URL in an embedded script block of the web document. The web browsers can then download and evaluate a cache manifest referenced in the web document in a step 2010. The cache manifest can reference the token URL in a step 2025.

Similarly, the web browser can request a web document from the local web server in a step 2015. In a step 2020, the local web server can deliver the web document containing the same token URL in an embedded script block of the web document. From both the step 2010 and the step 2020, the token URL can be read by the electronic device. Accessing of copies of the token file stored on the web browser cache can then be achieved via directing the web browser to the token URL in a step 2030.

FIG. 21 illustrates two options of caching a token file in a web browser, such as the browser 110 of FIG. 1. The web browser can include at least two types of caches. The web browser can include application caches. The application caches include application cache groups, each identified by a cache manifest absolute URL 2100. Each application cache group contains application caches that contain cached resources 2105 from the web applications referencing the same cache manifest. In at least one embodiment, a token file is a resource in the application cache, where a copy of the token file 2110 is stored in the application cache.

The web browser also contains a shared cache 2115 taking copies of any resources to be cached. In one embodiment, a token copy is delivered with cache instructions attached to HTTP connection headers. Based on the cache instruction, the web browser can then store a copy of the token file 2120 in the shared cache.

FIG. 22 illustrates a system of token information being shared between web browser sessions and application sessions via storage-based transport of the token in web browser caches and electronic device shared data storages, according to one embodiment of the invention. FIG. 22 shows a control flow of two types of transitions, click requests and application starts, as well as technologies for the interconnections to share information including caches and native shared data stores.

An advertisement can trigger a “Click 1” for proposed installation of “App A” 2205 that leads to a token file copy 2215 being stored in a web browser application cache 2200. The click can also trigger a token file copy 2210 being stored in a shared cache 2220 of the web browser. Then there can be a “Click 2” for proposed installation an “App B” 2240 later in time that consumes token information from the token file copy 2215 stored in the application caches 2200. App A can be running on an electronic device consuming token information from the token file copy 2210 in the shared cache 2220 of the web browser. The App A 2225 can store derived token information 2230 in a shared data store 2235 on the electronic device that the App A 2225 is installed on. The App B 2245 later in time, running on the same electronic device can consume the token information 2230 from the shared data store 2235. Here, it is illustrated that all Click (advertising entity) and App (installed entity) entities in the embodiment communicate token information and further information (i.e., about themselves and their environment) to the web service 2250, such as the supplier service system 210 of FIG. 2. It is noted that in this illustration, the web service is able to connect information of the entities and their identification via token information because the token is unique and broadcasted between the entities.

It is noted that for the methods described in FIGS. 1-22 above, some or all of the steps described can be executed in parallel to other steps described. The steps can also be executed sequentially as illustrated. In other embodiments, some steps can be executed asynchronously to preceding steps.

In the above description, instances of the token 106 can be referred to as the unique token, the token file, the token, the token information, the token object, or any combination thereof. Instances of the native application 114 can be referred to as the application or the installed application. The web service system 104 can be referred to as the web service or the supplier web service. Web links are described as URLs (i.e., Uniform Resource Locator) in this disclosure. However, other formats of linking resources across the network and within electronic devices are also contemplated by this disclosure.

Referring now to FIG. 23, therein is shown a diagrammatic representation of a machine in the example form of a computer system 2300 within which a set of instructions, for causing the machine to perform any one or more of the methodologies or modules discussed herein, may be executed.

In the example of FIG. 23, the computer system 2300 includes a processor, memory, non-volatile memory, and an interface device. Various common components (e.g., cache memory) are omitted for illustrative simplicity. The computer system 2300 is intended to illustrate a hardware device on which any of the components depicted in the example of FIGS. 1 and 22 (and any other components described in this specification) can be implemented. The computer system 2300 can be of any applicable known or convenient type. The components of the computer system 2300 can be coupled together via a bus or through some other known or convenient device.

This disclosure contemplates the computer system 2300 taking any suitable physical form. As example and not by way of limitation, computer system 2300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 2300 may include one or more computer systems 2300; be unitary or distributed; span multiple locations; span multiple machines; or reside in a cloud, which may include one or more cloud components in one or more networks. Where appropriate, one or more computer systems 2300 may perform without substantial spatial or temporal limitation one or more steps of one or more methods described or illustrated herein. As an example and not by way of limitation, one or more computer systems 2300 may perform in real time or in batch mode one or more steps of one or more methods described or illustrated herein. One or more computer systems 2300 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 2300. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 2300. The interface can include an analog modem, isdn modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 23 reside in the interface.

In operation, the computer system 2300 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a token to store on an electronic device during a first browser session accessing a web service, the token stored on a shared browser cache;
capturing the token during an active session of a native application through the shared browser cache, the shared browser cache being accessible by browser sessions with different web domains; and
delivering the token to the web service.

2. The method of claim 1, wherein publishing the token to store in the first browser session includes publishing the token when the first browser session accesses a web service to process an advertisement click request.

3. The method of claim 1, wherein delivering the token includes delivering unique identifier of the electronic device.

4. The method of claim 1, wherein capturing the token is performed while the electronic device is offline from an external Internet network.

5. The method of claim 1, wherein capturing the token includes:
opening a local web server on the electronic device;
capturing the token by retrieving the token from the shared browser cache during a local browser session with the local web server.

6. The method of claim 5, wherein the local web server restricts access to only requests from the electronic device.

7. The method of claim 5, wherein the local web server provides resources via alphanumeric hash identifiers.

8. The method of claim 5, wherein the local web server timeout on the electronic device after a fixed duration.

9. The method of claim 1, wherein publishing the token includes publishing the token as a multimedia file.

10. The method of claim 1, wherein publishing the token includes publishing the token as an image file.

11. The method of claim 1, further comprising re-caching the token on the shared browser cache on a subsequent browser session from the first browser session.

12. The method of claim 1, further comprising storing a duplicate of the token on an application browser cache.

13. The method of claim 1, further comprising storing a duplicate of the token in a browser cookie.

14. The method of claim 1, further comprising storing a duplicate of the token in a shared data store between applications of the electronic device.

15. An method for advertisement conversion tracking comprising:
providing an advertisement content including an advertised application;
receiving an execution request for execution of the advertisement content on a web service system;
depositing a token on a browser cache of the electronic device in response to the request;
receiving the deposited token from the advertised application;
detecting an installation of the advertised application on the web service system by comparing the token with an execution request record on the web service system.

16. The method of claim 15, wherein the token is encoded.

17. The method of claim 16, further comprising sending a decode script to the electronic device to decode the token.

18. The method of claim 15, wherein depositing the token includes sending a web document to the electronic device including a cache manifest containing a reference to a token link with a cache instruction to save the token associated with the token link.

19. The method of claim 15, further comprising saving a token record entry associated with the token specific for an IP address of a requester in a temporary storage of the web service system to bridge multiple requests of the token.

20. An advertisement conversion tracking system comprising:
a supplier web service system configured to provide an advertisement content including an advertised application; and
an electronic device configured to:
receive the advertisement content; and
request an execution of the advertisement content;
wherein the supplier web service system is configured to deposit a token on a browser cache of the electronic device in response to the request for execution of the advertisement content;
wherein the electronic device is configured to notify the supplier web service system of an installation of the advertised application by delivering the token stored on the browser cache.

21. An electronic device comprising:
a processor;
a non-transitory storage medium storing instructions to:
receive a token to store on an electronic device during a browser session accessing a web service, the token stored on a shared browser cache;
capture the token during an active session of a native application through the shared browser cache, the shared browser cache being accessible by browser sessions with different web domains; and
deliver the token to the web service.
